(19) United States
(12) Patent Application Publication
(10) Pub. No.: US 2024/0220902 A1
(43) Pub. Date: Jul. 4, 2024

(54) SYSTEMS AND METHODS FOR AUTOMATIC HANDLING OF SCORE REVISION REQUESTS

(71) Applicant: Nice Ltd., Ra'snana (IL)

(72) Inventors: Pavan LAHOTI, Pune (IN); Shivdatta Morwadkar, Pune (IN); Jitendra Takalkar, Pune (IN)

(73) Assignee: Nice Ltd., Ra'anana (IL)

(21) Appl. No.: 18/093,107

(22) Filed: Jan. 4, 2023

(51) Int. Cl. G06Q 10/0639; G06Q 30/01

(52) U.S. Cl. CPC G06Q 10/06393; G06Q 30/01

(57) ABSTRACT

A method and a system for revising a score associated with interaction feedback, wherein the method may include: traversing a score revision decision tree to categorize the interaction, based on interaction data and interaction feedback data associated with the interaction; and selecting, based on the categorization of the interaction, an indication of a probability that the score associated with the interaction feedback should be revised; wherein interaction data may include data extracted from the interaction; interaction feedback data may include data extracted from feedback about the interaction; and the score revision decision tree may include a decision tree data structure including at least one decision node, each decision node including to at least one data point of the interaction data or interaction feedback data.

### FIELD OF THE INVENTION

The present invention relates generally to automatically revising scores associated with interactions based on data extracted from the interactions and interaction feedback.

### BACKGROUND OF THE INVENTION

Contact centers may handle large numbers of interactions including data (e.g. voice or video recordings, text exchanges, metadata, etc.) between parties such as customers and contact center agents. The agents may be expected to interact with the customers in a way that is constructive, that is polite, and/or that meets certain interaction guidelines/rules. An interaction which does not meet a set of expectations (whether those above or otherwise), may be unsatisfactory to the contact center.

It may be desired to find systems and methods which accurately classify interactions as satisfactory or unsatisfactory and/or systems and methods which accurately settle disputes as to whether an interaction is satisfactory or unsatisfactory (e.g. after an interaction has been incorrectly classified). It may in some cases be desired to find systems and methods which carry out the above processes automatically.

### SUMMARY

Embodiments of the invention may relate to a method for revising a score associated with an interaction, wherein the method may include: traversing a score revision decision tree to categorize the interaction, based on interaction data and interaction feedback data associated with the interaction; and selecting, based on the categorization of the interaction, an indication of a probability that the score associated with the interaction should be revised; wherein interaction data may include data extracted from the interaction; interaction feedback data may include data extracted from feedback about the interaction; and the score revision decision tree may include a decision tree data structure including at least one decision node, each decision node corresponding to at least one data point of the interaction data or interaction feedback data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic drawing of a system according to some embodiments of the invention.

FIG. 2 is a schematic drawing of a system according to some embodiments of the invention.

FIG. 3 is a flowchart outlining a method for ascertaining whether a request for revising an interaction score should be raised according to some embodiments of the invention.

FIG. 4 is a flowchart outlining a method for ascertaining whether a request to revise an interaction score should be raised to a supervisor according to some embodiments of the invention.

FIG. 5 is a flowchart outlining a method for ascertaining whether an interaction score should be revised by a score revision handling engine according to some embodiments of the invention.

FIG. 6 is a flowchart outlining a method for analyzing whether a score associated with an interaction should be revised according to some embodiments of the invention.

FIG. 7 is a schematic drawing of a decision tree data structure according to some embodiments of the invention.

FIG. 8 is an architecture diagram indicating an example dataflow according to some embodiments of the invention.

FIG. 9 is a flowchart for a method for automatic score revision according to some embodiments of the present invention.

### DETAILED DESCRIPTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items.

As used herein, “contact center” may refer to a centralized office used for receiving or transmitting a large volume of enquiries, communications, or interactions. The enquiries, communications, or interactions may utilize telephone calls, emails, message chats, SMS (short message service) messages, etc. A contact center may, for example, be operated by a company to administer incoming product or service support or information enquiries from customers/consumers.

As used herein, “call center” may refer to a contact center that primarily handles telephone calls rather than other types of enquiries, communications, or interactions. Any reference to a contact center herein should be taken to be applicable to a call center.

As used herein, “interaction” may refer to a communication between an agent and a customer, and may include, for example, voice telephone calls, email, web chat, SMS, etc. An interaction may be recorded. An interaction may also refer to the data which is transferred and stored in a computer system recording the interaction, including for example voice or video recordings, metadata describing the interaction or the parties, etc. Interactions herein may be “computer-based interactions”, e.g. voice telephone calls, email, web chat, SMS, etc. Interactions may be computer-based if, for example, the interaction has associated metadata stored or processed on a computer, the interaction is tracked or facilitated by a server, the interaction is recorded on a computer, data is extracted from the interaction, etc. Some computer-based interactions may take place via the internet, such as some emails and web chats, whereas some computer-based interactions may take place via other networks, such as some telephone calls and SMS messages.

As used herein, “agent” may refer to a contact center employee that answers incoming interactions, and may, for example, handle customer requests.

As used herein, “customer” may refer to the end user of a contact center. Customers may be customers of the company that require some kind of service or support.

As used herein, “feedback”, “interaction feedback”, or “post-interaction feedback” may refer to information and/or opinions provided (directly or indirectly) by the customer to the contact center after (or possibly during) an interaction between the customer and an agent. Feedback may be in response to feedback questions, which may be defined by the contact center. The feedback may relate, for example, to the customer's experience with the contact center, the interaction, and/or the agent. The feedback may, for example, include numerical data, such as ratings of customer service on a scale of 1-10, and/or the feedback may include textual data, such as opinions on service provided. Feedback and/or feedback data may be collected using a survey. In some embodiments, feedback may provide indications of whether key performance indicators have been met during the interaction. Key performance indicators may be defined by the contact center and may, for example, include, a response time, a resolution time, a customer satisfaction, etc.

As used herein, “survey” may refer to the means through which feedback data is obtained from the customer. A survey may include, for example, questionnaires, opinion polls, or similar.

As used herein, “feedback data” may refer to data which quantifies, is related to, and/or is extracted from the feedback. Feedback data may be raw data or normalized data. Feedback data may include one or more of the following relevant parameters: categories featured in the feedback (e.g. problems discussed, remedies discussed, agent knowledge, agent behavior, etc.), and/or feedback sentiments (e.g. positive, neutral, or negative), which may include an overall feedback satisfaction sentiment (e.g. how was the interaction rated overall), and/or feedback category sentiments (e.g. how was a specific feedback category rated). Some categories may not have a category sentiment. Data may be extracted from the feedback using feedback management systems, as may be known in the art. Extracting data from feedback using interaction analytics systems may be particularly advantageous within the present invention, since it may obviate the need for review of the feedback by a supervisor.

As used herein, “raw data” may refer to data which has been extracted from a source (e.g. feedback data extracted from a survey), but which has not been through a normalization or substantive processing or preprocessing.

As used herein, “normalized data” may refer to data which has been normalized, in that the data is standardized and/or structured. In some embodiments, normalization may also include converting a non-numerical data point into a numerical data point. This may be achieved, for example, through label encoding and/or one-hot encoding algorithms, and may be useful during classification processes.

As used herein, “normalizing” may refer to the act of converting or changing, data from one form such as a raw form to another form such as a normalized form.

As used herein, “score” or “interaction score” may refer to a value given to an interaction to indicate a perceived quality or satisfaction with the interaction, and/or with the agent during the interaction. The score may be based on the feedback data. A score may be revised or adjusted, for example, in the light of diverging information (e.g. using interaction data) and/or using the methods of the present invention. The score may be given/stored as a category, for example, in one embodiment, the score may be given as “acceptable” or “unacceptable”. In another embodiment, the score may be given as “low”, “medium”, or “high”. In a further embodiment, a score may be given as a number, for example, an integer between 1 and 10. In each example, there may be a limit or cutoff, wherein a particular score may have a value (e.g. “low”) or one of a group of values (e.g. 1≤score≤3) which are deemed to be unsatisfactory. An unsatisfactory score may be unfavorable to the agent associated with the interaction. An agent may be able to challenge an unsatisfactory score by raising an interaction score revision request/appeal. In the following description, the score will be described as “low” and/or “high”, where “low” is deemed to be unsatisfactory, but this should not be read as limiting the form of the score.

As used herein, “interaction data” may refer to data which has been directly extracted from an interaction or a recording thereof (e.g. a sound recording). Interaction data may be raw data or normalized data. Interaction data may include one or more of the following relevant parameters: categories featured in the interaction, a category confidence (e.g. a percentage confidence) (e.g. what is the confidence that a category, or its associated sentiment, is correct, or has been correctly categorized), category sentiments (for some or all categories) (e.g. positive, neutral, or negative), an overall sentiment of the interaction (e.g. positive, neutral, or negative), a frustration of the interaction (e.g. between 0.0 and 1.0), and/or an overall interaction confidence (e.g. a percentage confidence) (e.g. what is the confidence that the overall sentiment is correct). Data may be extracted from the interaction using interaction analytics systems, as may be known in the art. Extracting data from interactions using interaction analytics systems may be particularly advantageous within the present invention, since it may obviate the need for review of the interaction by a supervisor, which may substantially reduce the time needed to review interactions (interaction recordings may last for a non-trivial length of time, e.g. 10-15 minutes).

As used herein, “decision tree” may refer to a data structure including, or capable of representing, a series of linked nodes. Decision trees may be used for classification of an instance/object into a certain class by interrogating features of the instance/object. The linked nodes may include a root node, at least one leaf node (or terminal node), and possibly one or more internal nodes, wherein the root node may be connected to a plurality of child nodes (internal or leaf), the internal nodes may be connected to one parent node (internal or root) and a plurality of child nodes, and the leaf node may be connected to one parent node. To classify an object/instance with a decision tree, it may be traversed, wherein traversal begins at the root node. Each root node or internal node may interrogate a feature of the object in a way that categorizes the object into one of a plurality of categories (often two categories corresponding to two child nodes). Each of these categories may be associated with one of the plurality of connected child nodes, and when an object is found to be in one of the categories, the traversal of the decision tree may move to the associated child node. This process may continue until the presently considered node of the traversal is a leaf node. Each leaf node may be associated with a class or classification of the object and may not further interrogate features of the object. In some embodiments, decision trees may be implemented with object-oriented programming. In some embodiments, a decision tree may be constructed based on existing/past data (e.g. in the case of a score revision decision tree, data may include existing interaction, feedback, and score data, which may also be associated with an indication of whether the score should actually be revised, e.g., as already decided by a supervisor). Construction of a decision tree may be configured to maximize/minimize a metric, such as constructing a decision tree so as to maximize an information gain metric, as may be known in the art. In some embodiments, the features that are most important for categorization may be higher up or closer to the beginning/root of the tree, and features that are less important may be further from the root.

As used herein, “score revision decision tree” may refer to a decision tree configured to classify interactions and their associated data, in order to determine an indication of probability that a score should be revised (the class) in accordance with embodiments of the present invention. A score revision decision tree may utilize interaction data and feedback data in the determination of an indication of probability that a score should be revised. In some embodiments, the classification and/or the tree may be one-class, binary, or multi-class. In one non-limiting example of multi-class classification, the classes may include high probability of rejection, low probability of rejection, low probability of acceptance, and high probability of acceptance. The score revision decision tree may be a regression tree and/or a classification tree.

As used herein, “score revision” may refer to a process of revising or adjusting a low or unsatisfactory score (usually a score to which the associated agent objects). Revising a score may include, for example, changing a score from “low” to “high”. This may take place after a review of the interaction.

As used herein, “supervisor” may refer to a contact center employee that, possibly among other responsibilities, reviews disputes raised about scores given to interactions. The supervisor may in some cases have a final say as to whether a score is revised. A supervisor may also be known as a dispute manager.

As used herein, “(overall) interaction sentiment” and “(overall) feedback sentiment” may refer to ratings or evaluations which are outcomes of an analysis performed on the interaction and interaction feedback, respectively. For example, the performed analysis may include a text analysis performed on a transcript of a call or the text response of a survey. The analysis may include, for example, a search for words indicative of a certain sentiment or category. A sentiment may be given as a value following such analysis, such as a percentage: for example, 60% overall positive sentiment. A positive sentiment may, for example, indicate happiness and satisfaction of the customer and/or friendliness or helpfulness of the agent, whereas a negative sentiment may indicate unhappiness and dissatisfaction of the customer and/or unfriendliness or unhelpfulness of the agent. In some embodiments, interaction sentiment may include a combination of separate constituent customer and agent sentiments. For example, interaction sentiment may be an average of customer and agent sentiment during the interaction. Since interaction feedback does not ordinarily involve an agent directly, this may only ordinarily relate to customer sentiment.

As used herein, “Customer/Agent Sentiment” may refer to ratings or evaluations, typically related to satisfaction or positive or negative feelings, or other subjective ratings, which are outcomes of an analysis performed on the interaction, for example a text analysis performed on a transcript of a call, wherein customer sentiment and agent sentiment may be separately calculated variables. Sentiments may be a percentage: for example, 60% customer positive sentiment. A customer sentiment may relate to customer happiness and satisfaction with the interaction, whereas an agent sentiment may relate to friendliness and helpfulness of the agent's handling of the interaction. In some embodiments, customer sentiment and agent sentiment are not considered separately (e.g. there is one overall interaction sentiment and/or one overall feedback sentiment). Embodiments in which customer sentiment and agent sentiment are not considered separately may have lower computing resource or memory requirements.

As used herein, “interaction categories” and “feedback categories” may refer to categorizations which are outcomes of an analysis performed on the interaction and interaction feedback respectively (or their data). For example, the performed analysis may include a text analysis performed on a transcript of a call or the text response of a survey. A category may be given as a value following such analysis, such as a string value: for example, categories may include the specific good/service that was discussed, the reason given for the interaction, the remedies discussed, agent behavior, agent knowledge, product knowledge, service, issue handling, issue resolution, etc. Categories may additionally or alternatively be given numerical values, e.g. through the use of label encoding and one-hot encoding algorithms. The analysis may include reviewing or searching interaction data and/or feedback data for indications of positive and/or negative interactions. In some embodiments, some or all categories may have a category sentiment (e.g. from an analysis performed on the interaction data and interaction feedback data) (e.g. positive, neutral, or negative).

Unless otherwise indicated, “sentiment”, “interaction sentiment”, and “feedback sentiment”, as used herein, refers to overall sentiments and/or category sentiments. Specific examples of various categories, ratings, etc. are disclosed herein, but other ranges of values or times and other ways of describing interactions and other entities may be used.

As used herein, “interaction frustration” may refer to ratings or evaluations which are outcomes of an analysis performed on the interaction, for example the performed analysis may include a voice analysis performed on a recording of a call. A frustration may be given as a value following such analysis, such as a percentage: for example, 10% frustration with the interaction. Frustration may be calculated/analyzed using factors such as voice volume, pitch, speed, etc. Similarly to sentiment, interaction frustration may in some embodiments be given or calculated separately for the customer and for the agent. In such a case, it would be possible to distinguish between frustration of the customer and that of the agent, which may be advantageous for a subsequent process of score revision (e.g. observable agent frustration may be more concerning and less desirable to the contact center than customer frustration). In other embodiments, customer frustration and agent frustration are not considered separately. These embodiments may improve prior evaluation technology due to lower computing resource or memory requirements.

As used herein, “engine” may refer to a computer algorithm or a piece of computer software that may provide a specific functionality within an overall system or method (e.g. survey engine, recommendation engine, revision engine). For example, a recommendation engine may be applied to produce an indication of whether or not a low score is accurate in accordance with some embodiments of the present invention. In some embodiments, an engine may be packaged as a software library. In some embodiments herein, “service” may have a somewhat similar meaning to engine, and may be configured to provide specific functionality within an overall system or method.

As used herein, “revising” may refer to a process of changing, adjusting, or updating, for example, changing, or updating data values, which may be stored in computer memory. For example, a score value may be revised if an agent were to believe that it did not fairly reflect a client-agent interaction to which the score corresponds. Revising the score may include changing, adjusting, or updating a memory value for the score. Revising a score may include updating, in that an old score may be changed or adjusted to be replaced by a new score, for example, as recommended by a recommendation engine.

As used herein, “traversing” may refer to moving through/along a decision tree, which may begin at a root node of the tree and may end at a leaf node of the tree. At each root node or internal node, a query (or conditional statement) may be asked about some data and the subsequent movement to a new mode may be based on an answer to the query, for example, if the answer is “True”, traversing may involve moving to one node, and if the answer is “False”, traversing may involve moving to a different node. Traversing may involve executing computer code in a computer processor, wherein data values may be retrieved from computer memory. For example, if the decision tree were embodied as a computer program including several nested conditional statements, traversing may refer to executing the computer program.

As used herein, “selecting” may refer picking or choosing. Selecting may be automatic, for example if the selection is based on an interaction categorization, then the categorization may, in some embodiments, lead to an automatic selection of a probability that may be associated with the categorization. Selecting may involve selecting from computer memory.

As used herein, “comparing” may refer to evaluating two or more data points or data sets against one another. Comparing may involve finding similarities, differences, and/or a correspondence between the data points or data sets.

As used herein, “displaying” may refer to conveying information to a user, for example, through means of a computer and/or output devices. For example, displaying may refer to showing information on a computer monitor or similar, so that a user may see a representation of the information visually. In other embodiments, displaying may, for example, refer to conveying information auditorily (e.g. via speakers), or by other means (e.g. haptic technology) or combination of means (e.g. virtual reality systems) that may convey information to a user.

As used herein, “applying” may mean to run or to use. In some embodiments, applying may mean to call a computational function.

As used herein, “searching” may include, for example, searching or otherwise analyzing source data for particular words in a larger text, for example, searching for words with positive connotations or negative connotations in customer feedback, or in a transcript of an interaction. Searching may additionally or alternatively include searching for particular sound patterns in a sound recording. Searching may additionally or alternatively include searching for other information, such as word lengths, voice volume, etc.

Unless explicitly stated, the method embodiments described herein are not constrained to a particular order or sequence. Additionally, some of the described method embodiments or elements thereof can occur or be performed simultaneously, at the same point in time, or concurrently.

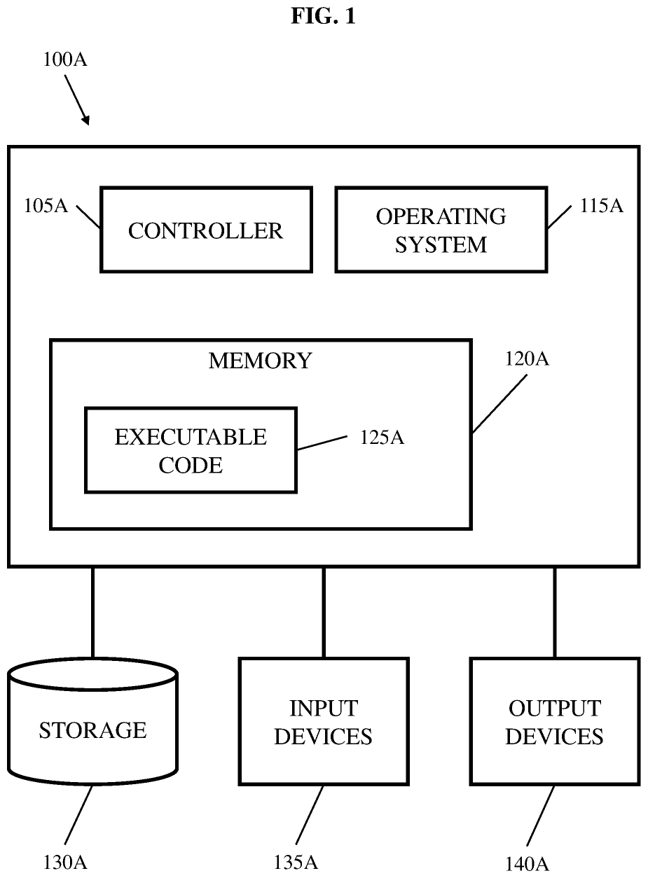

FIG. 1 shows a block diagram of an exemplary computing device which may be used with embodiments of the present invention. Computing device 100A may include a controller or computer processor 105A that may be, for example, a central processing unit processor (CPU), a chip or any suitable computing device, an operating system 115A, a memory 120A, a storage 130A, input devices 135A and output devices 140A such as a computer display or monitor displaying for example a computer desktop system.

Operating system 115A may be or may include code to perform tasks involving coordination, scheduling, arbitration, or managing operation of computing device 100A, for example, scheduling execution of programs. Memory 120A may be or may include, for example, a Random Access Memory (RAM), a read only memory (ROM), a Flash memory, a volatile or non-volatile memory, or other suitable memory units or storage units. At least a portion of Memory 120A may include data storage housed online on the cloud. Memory 120A may be or may include a plurality of different memory units. Memory 120A may store, for example, instructions (e.g. code 125A) to carry out a method as disclosed herein. Memory 120A may use a datastore, such as a database. Memory 120A may store, for example, a score revision decision tree, as may be used during a method as disclosed herein.

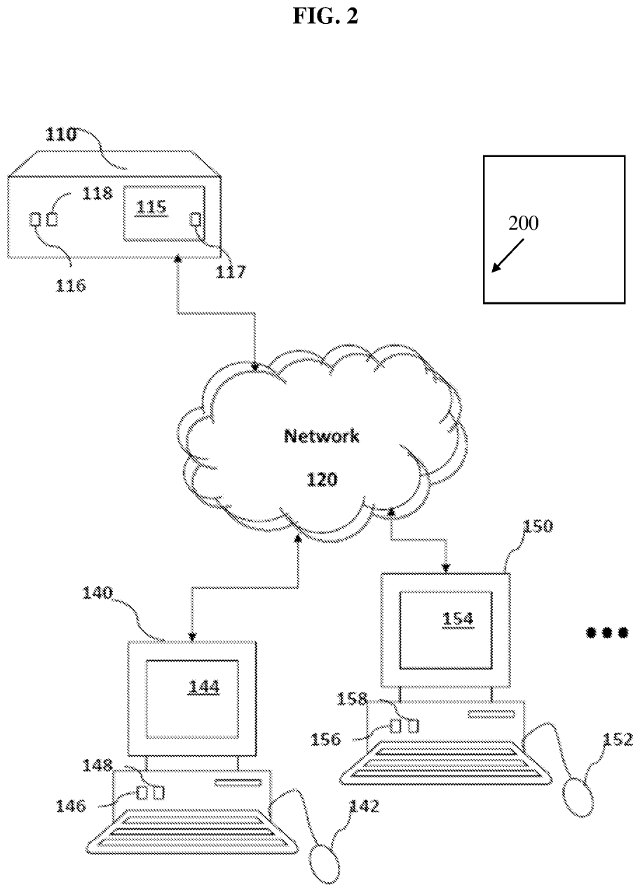

Executable code 125A may be any application, program, process, task, or script. Executable code 125A may be executed by controller 105A possibly under control of operating system 115A. For example, executable code 125A may be, or may execute, one or more applications performing methods as disclosed herein, such as revising a score associated with an interaction, and may be or act as various modules discussed herein, such as survey outcast service 815, a survey engine, CRM systems, a decision tree traversal process, recommendation engine, the components of FIG. 2, etc. In some embodiments, more than one computing device 100A or components of device 100A may be used. One or more processor(s) 105A may be configured to carry out embodiments of the present invention by for example executing software or code.

Storage 130A may be or may include, for example, a hard disk drive, a floppy disk drive, a compact disk (CD) drive, a universal serial bus (USB) device or other suitable removable and/or fixed storage unit. Data described herein may be stored in a storage 130A and may be loaded from storage 130A into a memory 120A where it may be processed by controller 105A. Storage 130A may include cloud storage.

Input devices 135A may be or may include a mouse, a keyboard, a touch screen or pad or any suitable input device or combination of devices. Output devices 140A may include one or more displays, speakers and/or any other suitable output devices or combination of output devices. Any applicable input/output (I/O) devices may be connected to computing device 100A, for example, a wired or wireless network interface card (NIC), a modem, printer, a universal serial bus (USB) device or external hard drive may be included in input devices 135A and/or output devices 140A.

Embodiments of the invention may include one or more article(s) (e.g., memory 120A or storage 130A) such as a computer or processor non-transitory readable medium, or a computer or processor non-transitory storage medium, such as for example a memory, a disk drive, or a USB flash memory encoding, including, or storing instructions, e.g., computer-executable instructions, which, when executed by a processor or controller, carry out methods disclosed herein.

FIG. 2 is a schematic drawing of a system 100 according to some embodiments of the invention. System 100 may include one or more server(s) 110, database(s) 115, and/or computer(s) 140, 150, . . . , etc., each of which may be or include computers (e.g., computer 100A) or components, such as shown in FIG. 1. Any or all of system 100 devices may be connected via one or more network(s) 120. Network 120, which connects server(s) 110 and computers 140 and 150, may be any public or private network such as the Internet. Access to network 120 may be through wire line, terrestrial wireless, satellite, or other systems well known in the art.

Server(s) 110 and computers 140 and 150, may include one or more controller(s) or processor(s) 116, 146, and 156, respectively, for executing operations according to embodiments of the invention and one or more memory unit(s) 118, 148, and 158, respectively, for storing data (e.g., indications of feedback categories, feedback sentiment, interaction categories, interaction sentiment, and interaction frustration according to embodiments of the invention) and/or instructions (e.g., methods for revising scores associated with interactions according to embodiments of the invention) executable by the processor(s). Processor(s) 116, 146, and/or 156 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 118, 148, and/or 158 may include, for example, a random-access memory (RAM), a dynamic RAM (DRAM), a flash memory, a volatile memory, a non-volatile memory, a cache memory, a buffer, a short-term memory unit, a long-term memory unit, or other suitable memory units or storage units.

Computers 140 and 150 may be servers, personal computers, desktop computers, mobile computers, laptop computers, and notebook computers or any other suitable device such as a cellular telephone, personal digital assistant (PDA), video game console, etc., and may include wired or wireless connections or modems. Computers 140 and 150 may include one or more input devices 142 and 152, respectively, for receiving input from a user (e.g., via a pointing device, click-wheel or mouse, keys, touch screen, recorder/microphone, other input components). Computers 140 and 150 may include one or more output devices 144 and 154 (e.g., a monitor or screen) for displaying data to a user provided by or for server(s) 110.

Any computing devices of FIGS. 1 and 2 (e.g., 100A, 110, 140, and 150), or their constituent parts, may be configured to carry out any of the methods of the present invention. Any computing devices of FIGS. 1 and 2, or their constituent parts, may include a recommendation engine or a score revision handling engine, which may be configured to perform some or all of the methods of the present invention. The systems and methods of the present invention may be incorporated into or form part of a larger platform, such as a client relationship management (CRM) platform, or a system/ecosystem, such as a customer feedback ecosystem. The platform, system, or ecosystem may be run using the computing devices of FIGS. 1 and 2, or their constituent parts.

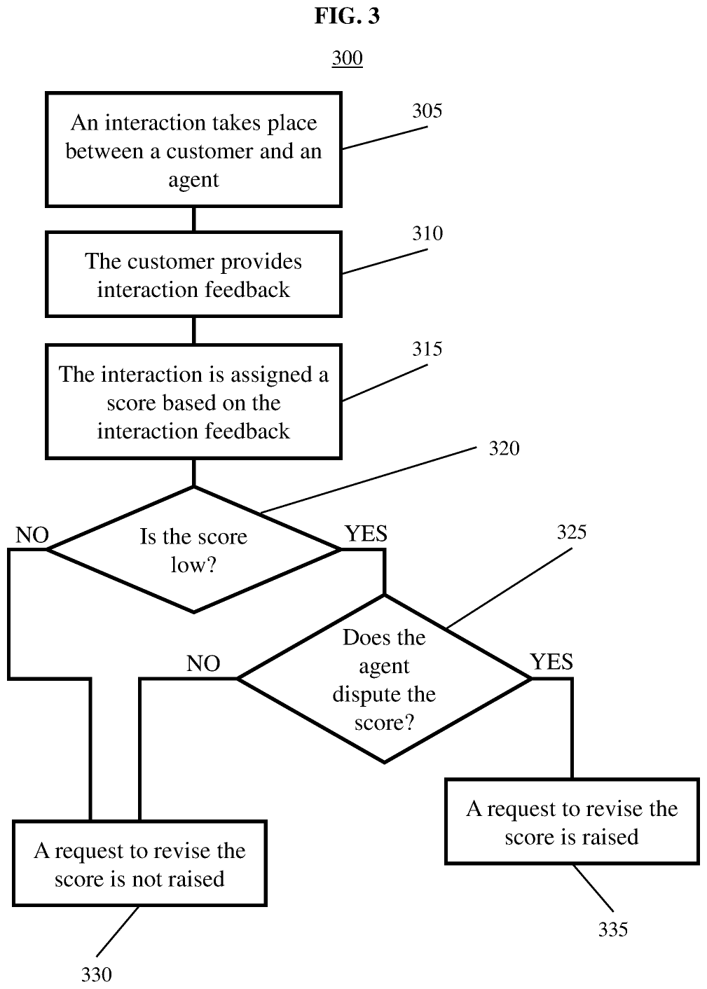

FIG. 3 depicts a flowchart of a method 300 for ascertaining whether a request for revising an interaction score should be raised according to some embodiments of the present invention. According to some embodiments, some or all of the steps of the method are performed (fully or partially) by one or more of the computational components shown in FIGS. 1 and 2.

In operation 305, an interaction may take place between a customer and an agent. As defined above, this interaction may take the form of various interaction types (e.g. telephone call). The interaction may be recorded. For example, an audio file of the interaction, in which the voices of the customer and the agent during the interaction are recorded, may be saved to computer memory.

In operation 310, the customer may provide interaction (or post-interaction) feedback. Interaction feedback may ask for a customer's opinion or perspective on the interaction. The interaction feedback may be analyzed to extract indications of feedback categories and/or feedback sentiments. For example, the feedback provided may take the form of an online survey, wherein characteristics of the interaction may be rated on a five-star scale, and/or on a scale of 1-10. The customer may, for example, rate the friendliness of the agent as 2 out of 10. In this example, when the interaction feedback is analyzed, this value may lower the extracted value of feedback sentiment. Feedback may additionally or alternatively take the form of text-based responses. For example, the customer may write “Great service! My refund was arranged promptly”, which may increase the extracted value of feedback sentiment, based on extracted words such as “great” and “promptly” which may have positive associations. In this example feedback categories may also be extracted, for example, that the feedback concerned a product/service refund.

In operation 315, the interaction may be assigned a score based on the interaction feedback. The score may be based on the feedback categories and/or feedback sentiments. For example, if feedback sentiments are negative, an associated score may be low (the score may be a category, e.g. “high” or “low”, as discussed above). In some embodiments, each feedback category may be associated with its own sentiment values, for example, it may therefore be known that the customer felt the quality of the discussed product was low, but the helpfulness of the agent during the interaction was high. In such an embodiment, each category may have a different impact on ascertaining/calculating the score. For example, sentiment towards the discussed product may have no or little relation/weighting to the quality of the interaction and may have no impact on the score, whereas helpfulness of the agent may have a strong impact/weighting on the interaction score. A low score may be assigned to interactions where there exist indications of negatively reported customer interactions and/or a high score may be assigned to interactions where there exist indications of positively reported customer interactions. The score may be calculated using a user defined formula and/or algorithm based on values associated with the sentiments and/or categories. In one non-limiting example, the score may be calculated by adding together all ratings on a, for example, 1-10 scale which the customer has provided (e.g. with ratings of 2/10, 5/10, 7/10, and 8/10, the overall score may be 22). In some embodiments, a non-numerical feedback datapoint (e.g. text-based responses) may be automatically assigned a numerical value based on properties of the feedback (e.g. using label encoding or one-hot encoding) and this value may be used when calculating a score (e.g. may be added to the score in the example above). The score may be converted from a number to a different value, for example, 25 in the example above may be converted to “low” based on an expected range of scores.

In operation 320, it may be assessed whether the score is low. Low scores may be indicative of a negatively reported customer experience, whereas higher scores may be indicative of a more positively reported customer experience. It may be decided whether a score is low based on a user-defined cutoff. If the score is not low (e.g. the score is medium or high), there may be no reason to review/revise the score. It may be advantageous to not raise a request to revise the score in every instance (e.g. when the score is medium or high), in order that computational resources and time are saved. The definition of whether a score is low may be user-defined (e.g. based on contact center priorities) and/or related to the quantity of resources (e.g. computational) available to review interactions. For example, the score cutoff may be defined such that the number of cases for which the score is revised may be roughly equal to the number of cases the contact center is computationally able to review. In the case that an answer to the question “Is the score low?” is “NO”, the method may move to operation 330, in which a request to revise the score is not raised. In the case that an answer to the question “Is the score low?” is “YES”, the method may move to operation 325.

In operation 325, it may be assessed whether the agent disputes the score (which may be a low score). The score may be displayed to the agent, for example, using a GUI and a computer monitor, e.g. via output devices 144 and 154. An agent may dispute a low score if, for example, they believe based on their experience or a recording of the actual interaction, that the score should be revised (to be higher). Sometimes, an agent may wish to dispute a low score if they believe that the probability that the score will be revised is high enough, according to personal preference. An agent may indicate that they dispute the score using a computational input device. An agent may first be shown information using a computational device that indicates that the interaction in question has been given a low score. An agent may choose to review evidence of the interaction, for example, a sound or video recording of the interaction, before they choose whether to dispute the score. An agent may submit the evidence/proof if/when they dispute the score, to back up or strengthen the resulting score revision request (so that it may be more likely to be revised). In some embodiments, the agent may additionally or alternatively submit comments or arguments supporting their request. Some or all of the functions associated with operation 325 may utilize a GUI (graphical user interface) for input and output, e.g. via output devices 144 and 154. In the case that an answer to the question “Does the agent dispute the score?” is “NO”, the method may move to operation 330, in which a request to revise the score may not be raised. In the case that an answer to the question “Does the agent dispute the score?” is “YES”, the method may move to operation 335, in which a request to revise the score may be raised.

In operation 330, a request to revise the score may not be raised. In this case, the interaction and score may not be raised to a recommendation engine, a score revision handling engine, and/or a supervisor. The score may be stored in memory, and may be associated with the agent.

In operation 335, a request to revise the score may be raised. For example, the interaction, its associated data (e.g. interaction recordings), and/or the associated score may be passed to a system (e.g. a recommendation engine, a score revision handling engine, and/or directly to a supervisor) for handling a revision for the score of the interaction.

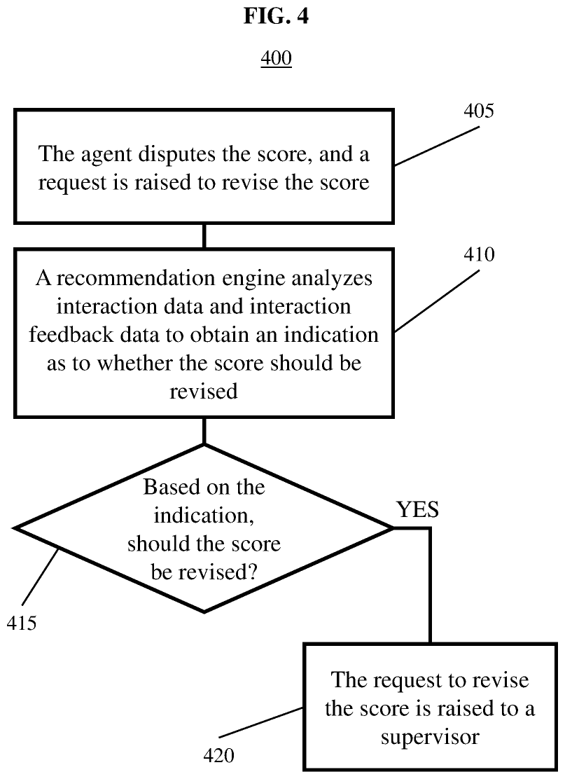

FIG. 4 depicts a flowchart for a method 400 for ascertaining whether a request to revise the score should be raised to a supervisor according to some embodiments of the present invention. According to some embodiments, some or all of the steps of the method are performed (fully or partially) by one or more of the computational components shown in FIGS. 1 and 2. The embodiment described by method 400 may relate to (partially) manual score revision.

In operation 405, the agent may dispute the score, and a request may be raised to revise the score. Operation 405 may incorporate steps described in method 300 (FIG. 3).

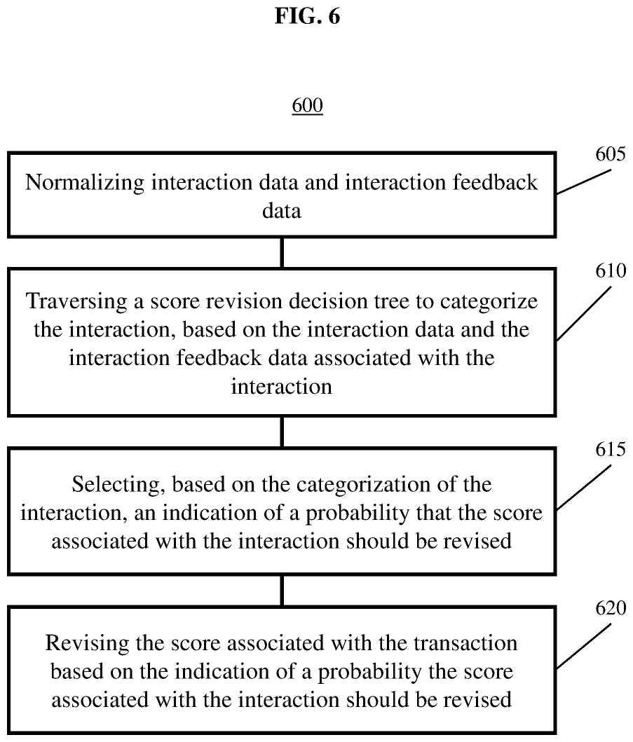

In operation 410, a recommendation engine may analyze interaction data and interaction feedback data to obtain/produce an indication or probability as to whether the score should be revised (or whether the score is accurate). The recommendation algorithm may be applied in order to produce the indication. The analysis may be as described with regard to FIG. 6. The indication that the score should be revised may be a data point, for example, a Boolean value of “True” or “False”, or a string such as “probable” or “improbable”, or a number, possibly representing a probability, for example “0.7” (wherein the number may indicate that a score should probably be revised if the number is more than 0.5).

In operation 415, it may be assessed whether the score should be revised, based on the indication (as to whether the score should be revised). For example, if the indication that the score should be revised were a Boolean variable, operation 415 may check that this data point is “True”. In the case that the answer to the question “Based on the indication, should the score be revised?” is “YES”, the method may move to operation 420, in which the request to revise the score may be raised to a supervisor. If the answer is “NO” or an equivalent, the method may choose not to raise the request.

In operation 420, the request to revise the score may be raised to a supervisor. The supervisor may be provided with a recommendation, which may include/incorporate the indication that the score should be revised. The recommendation may be provided using a GUI (graphical user interface). In one embodiment, text included in the recommendation may, for example, read “The system highly recommends accepting this request”. In some embodiments, the recommendation may include comments or arguments from the agent, if applicable. The supervisor may then choose, for example, based on the indication that the score should be revised or based on the supervisor's own review of the evidence (e.g. recordings), whether to revise the score. The supervisor may input this choice into a computer device, for example, using the GUI.

In some embodiments, the agent that disputed the score may be informed by a follow-up alert, or by another means, whether their revision request has been raised to the supervisor and/or whether the score has been revised by the supervisor.

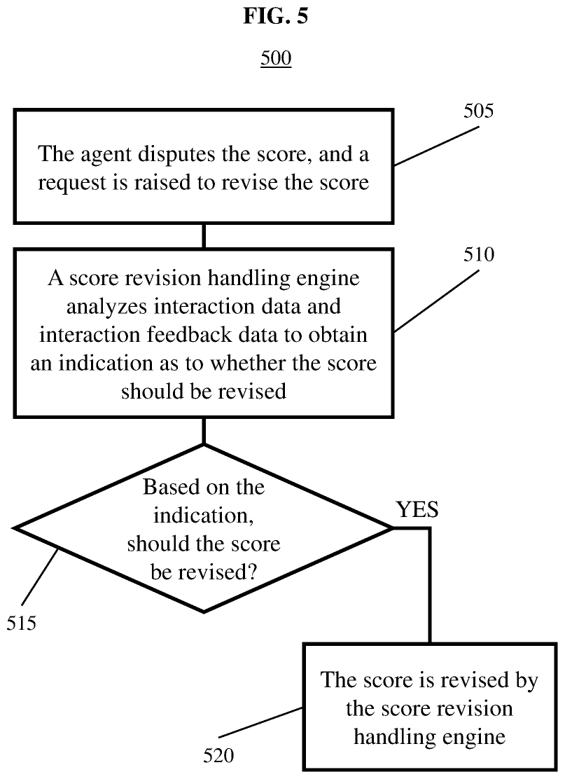

FIG. 5 depicts a flowchart for a method 500 for ascertaining whether the score should be revised by a score revision handling engine according to some embodiments of the present invention. According to some embodiments, some or all of the steps of the method are performed (fully or partially) by one or more of the computational components shown in FIGS. 1 and 2. The embodiment described by method 500 may relate to automatic score revision. Methods 400 and 500 may be alternatives, or, in some embodiments, may both be applied.

In operation 505, the agent may dispute the score, and a request may be raised to revise the score. Operation 505 may incorporate steps described in method 300 (FIG. 3). Operation 505 may be substantially similar to operation 405 of method 400 (FIG. 4).

In operation 510, a score revision handling engine may analyze interaction data and interaction feedback data to obtain an indication as to whether the score should be revised. The analysis may be as described with regard to FIG. 6 below. The indication that the score should be revised may be a data point, for example, a Boolean value of “True” or “False”, or a string such as “probable” or “improbable”, or a number, possibly representing a probability, for example “0.7” (wherein the number may indicate that a score should probably be revised if the number is more than 0.5).

In operation 515, it may be assessed whether, based on the indication, the score should be revised. For example, if the indication that the score should be revised were a Boolean variable, operation 515 may check that this data point is “True”. In the case that the answer to the question “Based on the indication, should the score be revised?” is “YES”, the method may move to operation 520, in which the score is revised by the score revision handling engine. If the answer is “NO” or an equivalent, the method may choose not to revise the score.

In operation 520, the score may be revised by the score revision handling engine. Revising the score may include changing/replacing/adjusting a value stored in computer memory associated with the interaction and/or the agent associated with the interaction. For example, where a score has been recorded as “low”, but the result of operation 515 is that, based on the interaction, the score should be revised, the data value may be overwritten to store “high”. As a result, an agent may, for example, not be penalized for an interaction in which the agent acted correctly/appropriately.

In some embodiments, the agent that disputed the score may be informed by a follow-up alert, or by another means, whether the score has been revised.

FIG. 6 depicts a flowchart for a method 600 for obtaining an indication as to whether a score should be revised according to some embodiments of the present invention. According to some embodiments, some or all of the steps of the method are performed (fully or partially) by one or more of the computational components shown in FIGS. 1 and 2.

In operation 605, interaction data and interaction feedback data may be normalized. Operation 605 may be an optional operation of method 600. For example, interaction data and interaction feedback data that are input into method 600 may already be normalized, or the score revision decision tree may allow for (be able to use) unnormalized data. Normalization may relate to producing data which is standardized (and may therefore be configured to be used during traversal of a decision tree). The interaction data and interaction feedback data may additionally or alternatively be subject to any other required preprocessing (e.g. some validation). Operation 605 may additionally or alternatively include converting non-numerical data into numerical data, for example, using label encoding or one-hot encoding.

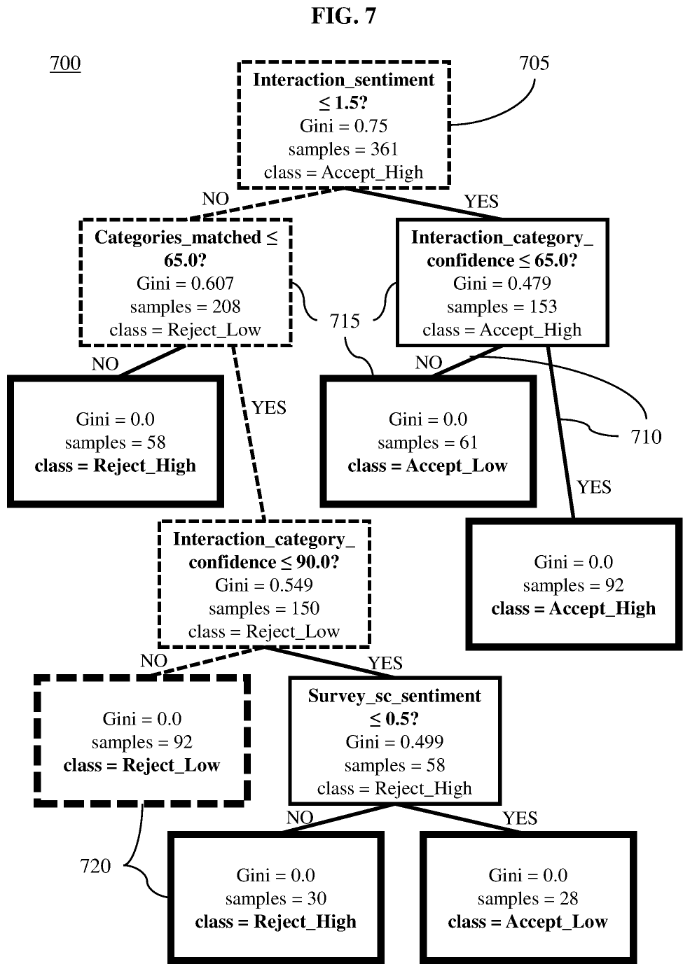

In operation 610, a score revision decision tree may be traversed to categorize the interaction, based on the interaction data and the interaction feedback data associated with the interaction. The score revision decision tree may be the same as or similar to the decision tree as previously described and/or as described with respect to FIG. 7. At each (non-leaf) node of the score revision decision tree, a query may be asked of at least one data point from the interaction data, the feedback data, and/or a combination thereof, and additionally or alternatively, a query may be asked of a data point that is calculated from the interaction data, the feedback data and/or a combination thereof. For example, a node may assess whether the interaction or a category thereof has a high frustration associated with it (e.g. Is the frustration more than 0.5 on a scale from 0 to 1?). If the answer is “yes”, then the traversal of the decision tree may branch to a new node in one way (a set of branches/nodes that deals with high frustration interactions), and if the answer is “no”, then the traversal of the decision tree may branch to a new node in an alternate direction (a set of branches/nodes that deals with low frustration interactions). By way of another example, a node may assess whether the interaction sentiment is higher than the feedback sentiment (e.g. is the following True: interaction sentiment—feedback sentiment >0). If the answer is “yes” or “True”, then the traversal of the decision tree may branch to a new node that deals with relatively higher interaction sentiment interactions, and if the answer is “no” or “False”, then the traversal of the decision tree may branch to a different new node that concerns relatively equal or lower sentiment interactions.

The traversal may continue until a leaf node is reached. The leaf node that is reached may give an indication of probability that the score should be revised. In one specific example, when there is high correspondence between the interaction data and feedback data, wherein the categories in each case include discussion of product refunds, and the level of frustration of the interaction is found to be high, it may be found by traversing the score revision decision tree that there is a low probability that the score should be revised (this example is non-limiting; a different probability may be found for this set of inputs).

In some embodiments, the score revision decision tree may be constructed using a continuous build-test model. Two datasets may be required: a training dataset and a testing dataset, wherein the training dataset allows for the construction of a tree, and the testing dataset allows for the accuracy of the tree to be tested, and refined through adjustment of the tree. Construction of a decision tree may be configured to maximize/minimize a metric, such as constructing a decision tree so as to maximize an information gain metric, as is known in the art (e.g. using a version of CART (classification and regression tree)). Once a tree/model has been trained to a suitable accuracy (e.g. >95% of requests are correctly classified), then it may be deployed, for example, for use in operation 610. Deploying the model may include hosting the model through an API (application programming interface) for use by recommendation and/or revision engines (or similar).

In operation 615, an indication of a probability that the score associated with the interaction should be revised may be selected, based on the categorization of the interaction (e.g. the categorization of operation 610). The indication of a probability that the score should be revised may, in some embodiments, be the categorization itself, for example the categories could be labelled “high probability”, “low probability”, etc. In some embodiments, the selection of an indication of a probability in operation 615 may be a direct result of the traversal of the score revision tree of operation 610, e.g. the category of the interaction of operation 610 may be a probability that a score should be revised. In other embodiments, the categorization of the interaction of 610 may be used to select an indication of a probability indirectly, for example, the categorization may be used in a lookup table to find an indication of probability (e.g. wherein the lookup table provides an indication of probability for categories).

In operation 620, the score associated with the transaction may be revised, based on the indication of a probability the score associated with the interaction should be revised. This may be an optional operation of method 600, for example, the request to revise the score may alternatively be raised to a supervisor. This operation may be carried out by a score revision handling engine, as in method 500. Score revision may relate to modifying at least one value associated with the score, stored in computational memory (e.g. to a value indicative of a more positive customer experience).

In some embodiments, method 600 may further include (for example, before traversing the score revision decision tree in operation 610) comparing the interaction data with the interaction feedback data to find a correspondence (e.g. a percentage match) between the interaction data and the interaction feedback data, and categorizing the interaction additionally based on the correspondence. For example, a correspondence may be that both the interaction data and the interaction feedback data have similar positive recorded sentiments, or by way of another example, that both the interaction data and the interaction feedback data discuss the category of cancelling a service subscription. Correspondences/correlations may aid in the categorization process, for example, if the feedback data is completely or substantially uncorrelated to the actual interaction as recorded by the interaction data, then this may mean that the customer gave unhelpful, bad faith, and/or unrelated feedback, and consequently the score revision decision tree may categorize the interaction with a high probability that the score should be revised. Using correspondences/correlations in the methods of the present invention may additionally or alternatively be known as comparative analysis.

FIG. 7 shows a schematic drawing of an exemplary decision tree data structure 700 according to some embodiments of the invention, where rectangles represent nodes, lines represent links, and a single exemplary path/traversal of the tree is shown with a dashed outline. In some embodiments, the score revision decision tree of the present invention may have a similar or analogous structure to the decision tree data structure 700. The decision tree data structure 700 may include a root node 705, leaf nodes, e.g., 720, internal nodes, e.g., 715, and links (possibly called branches or connectors), e.g., 710. Leaf nodes are indicated with bold outlines. Nodes may include decision points, wherein decision points may decide which link to commit to, based on values of certain data points. The tree data structure 700 may be similar to other trees and decision trees as already described.

FIG. 7 also shows exemplary data associated with each node; other specific data or data types may be used, and data may be in different forms. For example, FIG. 7 shows the outcome of training a tree data structure based on a selection of 361 interactions that may have already been manually classified. In the root and internal nodes, a question, query, or decision point is in bold, for example, in the specific example of FIG. 7, the root node may ask “is interaction sentiment less than or equal to 1.5?” If the answer is “YES”, a traversal of the decision tree may continue to the associated node via the associated link (e.g. to the right). If the answer is “NO”, the traversal may continue to an alternate associated node and link (e.g. to the left). The “samples” datapoint for each node may indicate the number of interactions in some training dataset that reached the node. The “Gini” datapoint for each node may indicate a likelihood of an interaction being incorrectly classified at that node, if classification were based on the distribution of interaction classes at that node in some training dataset. Training a decision tree data structure/model may involve minimizing the Gini value of nodes and/or of leaf nodes (all leaf nodes in the example have a Gini value of 0).

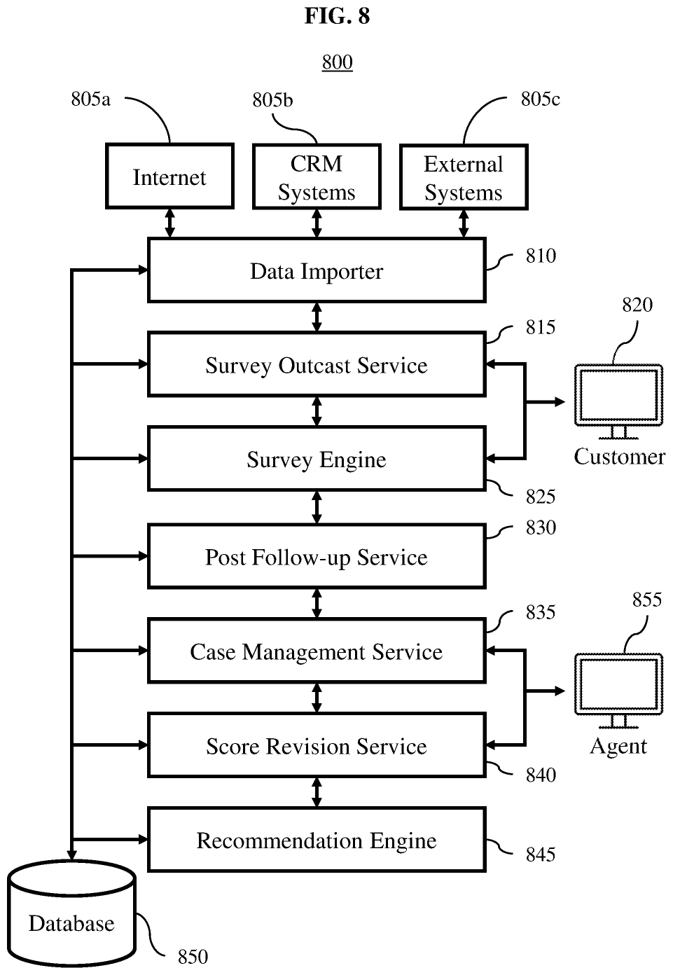

FIG. 8 shows an architecture diagram 800 indicating an example data flow according to some embodiments of the invention. The architecture diagram may for example collect interaction feedback, for example, after an interaction has finished. Arrows indicate movement of data or information between components of the architecture diagram. In embodiments of the invention it may not be required or optimal that data flows according to every arrow of the diagram, and in some embodiments, flows of data not depicted on the diagram may be possible, optimal or required. In some embodiments, some components of the diagram may be combined (e.g. a post follow-up service and case management service may be combined into one service) or split up (e.g. a score revision service could be split up into multiple services). In some embodiments, “service”, “engine”, and “system” may be interchangeable within the meaning of FIG. 8, and/or may be replaceable, or carried out with units such as, “module”, “code”, “program”, “segment”, “computer”, “server”, etc. In some embodiments, data may be sent and received by components of the architecture diagram that are not described herein, such as data related to operating systems, administration, etc.

In some embodiments, data may be obtained, for example, from the internet 805a, Customer Relationship Management (CRM) systems 805b, and external systems 805c. Other data sources may additionally or alternatively be used. The data sources may include or contain customer data. Customer data may include personal information, profile details, geographical information, preferences, addresses, phone numbers, email addresses, contact information etc. Different data sources may contain different pieces of customer data. The customer data may be required in order that surveys may be sent to customers. The data may move from at least one of the three data sources 805a-c to the data importer 810.

In some embodiments, a data importer 810 may retrieve or import the customer data from one or more of the data sources. The data importer may retrieve or import customer data that is sufficient in order that surveys may be sent to customers that have been involved in an (e.g., agent-customer) interaction. The data importer may store the customer data in computer memory and/or a database 850. The data may move from the data importer to the survey outcast engine 815 (possibly via a database/memory).

In some embodiments, a survey outcast service 815 may send surveys to one or more customers 820 (or a server or computational device whereby the customer may access, complete, and/or respond to the survey). Survey outcast service 815 may send surveys based on customer data, which may indicate how to send the surveys, such that the customer may be able to respond to the survey (e.g. customer data may include an email address). The customer data may be retrieved from computer memory and/or a database 850. Survey outcast service 815 may apply business-specific rules to the surveys, for example, the business-specific rules may standardize the form of surveys that are sent. Surveys may conform to survey templates, for example with set questions, such as “Was your query resolved?”, “How was your interaction?” and “Please rate the service of the customer service agent”. The customer data and/or data representing a survey may move from survey outcast service 815 to a customer 820, and/or a device associated with a customer (e.g. as shown in FIG. 2), and/or a system associated with a customer (e.g. a customer's personal computer or phone) (data may possibly also move to the survey engine). Business-specific rules, surveys, and/or survey templates may be stored in and/or retrieved from computer memory and/or a database 850.

In some embodiments, a customer or device/server associated with the customer 820 may receive the survey (or data indicative of a survey) from the survey outcast service (either directly or indirectly). A customer may (fully or partially) complete or fill out the survey and may submit the survey (for example, using a device associated with the customer). The completed survey may be sent to the survey engine. Data representing the completed survey may move from a device or system associated with the customer 820 to the survey engine.

In some embodiments, a survey engine 825 may collect, receive, or import survey responses from the customer(s) 820 (or associated devices). The survey engine may additionally store the responses in computer memory and/or a database 850. Customer responses/feedback may be as described with respect to operation 310 of FIG. 3. Data representing the received responses/surveys may move from the survey engine to the post follow-up service 830 (possibly via a database/memory).

In some embodiments, the interaction feedback may be obtained using a survey service. A survey service may, for example, include the data importer 810, the survey outcast service 815, and/or the survey engine 825. Customer data and/or survey responses may be imported and/or customer surveys may be provided/sent using an API (application programming interface), SFTP (secure file transfer protocol) integration, and/or CRM (customer relationship management) software. An API may allow for increased flexibility of the survey service in interacting with other devices or systems (e.g. devices associated with the customer). SFTP may allow for increased security of the transfer of confidential information, such as customer data. CRM software may allow for an integrated and seamless survey service. A person skilled in the art may recognize that additions and/or alternatives to each of the above exist in the art, which could perform the same or much the same role.

In some embodiments, a post follow-up service 830 may trigger an alert if a low score is detected for an interaction. The post follow-up service may be configured to assess whether an interaction should be assigned a low score, and/or may receive this information on how to assess a low score from a database/memory or a separate service or engine. Assigning a score to an interaction may be as described in operation 315 of FIG. 3, and may be based on factors such as interaction feedback sentiment (e.g., overall sentiment and/or category sentiment(s)). The interaction feedback may be searched for indications of negative and/or positive interactions, for example, positive words (e.g. “great”) may relate to positive interactions and may lead to the assignment of a low score. An alert may be triggered if the score falls below some threshold, for example, as described with respect to operation 320 of FIG. 3. In some embodiments, the post follow-up service may create a post follow-up case if the alert is triggered (optionally, in other embodiments, the alert may be sent to a case management service and the post follow-up case may be created by the case management service). The post follow-up case may be or include a selection of data that may include at least one recording or transcript of the interaction, the interaction score, etc. Data indicative of an alert and/or data indicative of a post follow up case may move from the post follow-up service to a case management service 835 and/or a database/memory (e.g. 850). The post follow-up service may receive data about the interaction from the survey service, survey engine, and/or a database/memory.

In some embodiments, a case management service 835 may receive a post follow-up case from the post follow-up service (possibly via a database/memory). The case management service may ask (or send a computational prompt or query to) an agent 855 that was involved in the interaction whether they wish to dispute the score if the score is low (and/or an alert was raised). The agent may be provided with information, such as that contained in the post follow-up case. In some cases the post follow-up case may be transferred by the case management service to a score revision service 840. The case management service may manage or oversee the case. For example, the case management service may track the case as it is opened, in-progress, and/or closed. After a score revision service and/or a recommendation engine decides whether a score should be revised, data indicative of this decision may be sent to the case management service (e.g., the case management may then close the case).

In some embodiments, an agent or device associated with the agent 855 may receive the question asking whether they wish to dispute a score (and possibly also accompanying information and data) from the case management service (either directly or indirectly). The agent may choose whether to request a score revision and may submit this response. The agent response may be sent to a score revision service 840. Data representing the agent response may move from a device or system associated with the agent 855 to the score revision service.

A score revision service 840 may receive a request to revise the score from the agent 855. It may also handle subsequent score revision recommendations and score revision, for example as discussed with regard to FIGS. 4-6, or alternatively, these recommendations may be performed by a recommendation engine 845. The score revision service may receive the post follow-up case from the post follow-up service, the case management service, or from a memory/database. If the agent revision request response is affirmative (the agent wishes to raise a revision request), the score revision service may send the post follow-up case and/or other information related to the interaction (between the agent and customer) to the recommendation engine. It may subsequently receive a recommendation from the recommendation engine (possibly via database 850) as to whether the score should be revised. If the recommendation states that the score should be revised, then the score may be revised/updated to a new score (usually higher). This new score may be stored in a memory/database. If the recommendation states that the score should not be revised, then the score may remain the same. The agent 855 may be informed of whether the score has been revised or has remained the same. Additionally, a supervisor may be informed of whether the score has been revised or has remained the same. In some embodiments, the supervisor may have the power to approve or reject score revision requests by interacting with the score revision engine through a separate device. In some embodiments, an indication of whether the score has been revised or has remained the same may be sent (or returned) from the score revision service to the case management service.

A recommendation engine 845 may provide recommendations on whether a score should be revised based on given evidence. The recommendation engine may be as described in operation 410 of FIG. 4. The recommendation engine may be configured to carry out some or all of the steps of FIG. 6. The recommendation engine may utilize a decision tree to automatically categorize an interaction and thus select a probability that the score of the interaction should be revised. The recommendation engine may thus provide a recommendation. The recommendation may be the probability that the score should be revised (e.g. “high probability that score should be revised”), or it may be based the probability and may give an instruction (e.g. “revise the score”). The recommendation or data indicative of the recommendation may move from the recommendation engine to the score revision service.

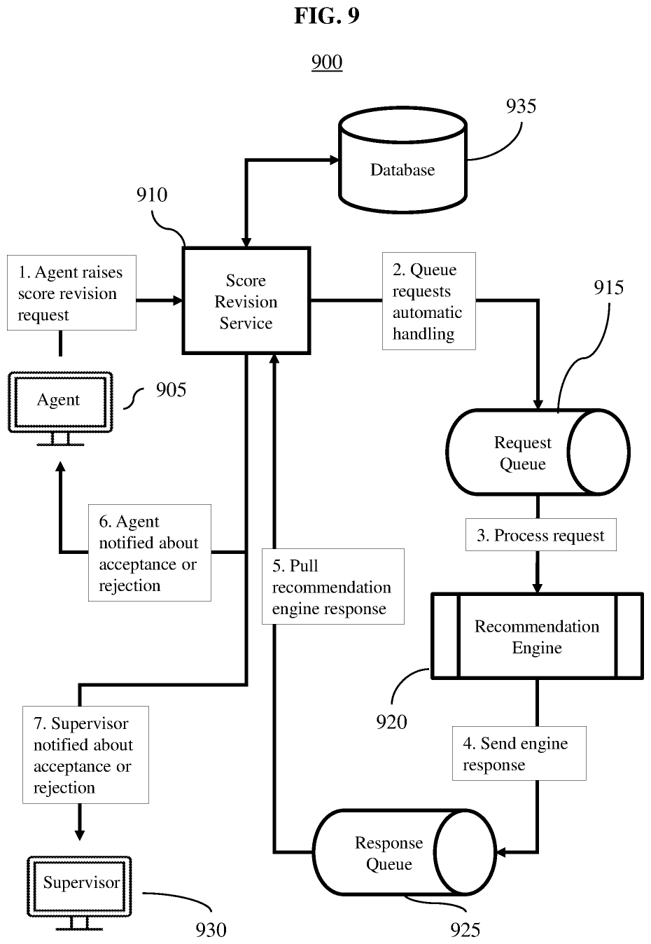

FIG. 9 depicts a flowchart for a method 900 for automatic score revision according to some embodiments of the present invention. According to some embodiments, some or all of the steps of the method are performed (fully or partially) by one or more of the computational components shown in FIGS. 1 and 2.

In operation 1, an agent 905 may raise a score revision request to a score revision service 910. A score revision request may be in response to the agent being informed of an interaction with a low score, wherein the agent wishes to dispute the low score. The request may ask for the score to be revised/increased/improved. The request may also include evidence of the interaction, such as recordings and transcripts. The request may also include the score. The score revision service may be as described with respect to component 840 of FIG. 8.

In operation 2, the score revision service 910 may add the score revision requests to a request queue 915. The request queue may be implemented in computer memory. The request queue may operate on a first in first out principle (e.g. the score revision request will be sent on to the next operation, only when there are no other requests in the queue that have been there longer). In some embodiments/circumstances, the score revision request may instead be sent from the score revision service to a recommendation engine 920 (and not to a queue), for example, if the request queue is empty or the volume of requests is low, there may be no need to send the revision request to a request queue.

In operation 3, the score revision request may be sent from the request queue 915 to a recommendation engine 920. The score revision request may thus be processed. The recommendation engine may be as described with respect to operation 410 of FIG. 4 or component 845 of FIG. 8. The recommendation engine may be configured to carry out some or all of the steps of FIG. 6. The recommendation engine may utilize a decision tree to automatically categorize an interaction and thus select a probability that the score of the interaction should be revised.

In operation 4, the response of the recommendation engine may be sent from the recommendation engine 920 to a response queue 925. The response of the recommendation engine may be of a form that is able to indicate a probability that the score should be revised, e.g. a Boolean value, a floating-point number between 0.0 and 1.0, a string such as “probable” etc. The response may be the same as or similar to the indication of a probability that the score associated with the interaction should be revised, as in FIGS. 4-6. The response queue may be implemented in computer memory. The response queue may operate on a first in first out principle. In some embodiments/circumstances, the response of the recommendation engine may instead be sent from the recommendation engine to the score revision service (and not to a queue), for example, if the response queue is empty or the volume of responses is low, there may be no need to send the response to the response queue.

In operation 5, the response of the recommendation engine may be pulled from the response queue 925 and may be sent to the score revision service 910. Based on the recommendation/response, the score revision service may decide whether to revise the score (e.g. as in operations 415 and 515 in FIGS. 4 and 5 respectively). If it is decided to revise the score, the score may be changed in database 935, such that the new score is recorded.

In operation 6, the agent 905 may be notified about the acceptance or the rejection of the score revision request which they sent (e.g. via a GUI and monitor).

In operation 7, a supervisor 930 may additionally or alternatively be notified about the acceptance or the rejection of the score revision request sent by the agent. The supervisor may also be given further information, for example, explaining which agent sent the request and information about the interaction.

Systems and methods of the present invention may improve existing interaction handling technology. For example, workflow may be automated; revision score requests may be processed without concern for availability of supervisors; revision score requests may be processed in a shorter time; revision score requests may be decided more accurately; an agent may be able to spend less time reviewing evidence and/or arguing for a score revision; agents may be able to spend time more productively, e.g., processing more interactions, increasing time spent on case management, increasing key performance indicators and/or increasing their billing hours; supervisors may be able to spend time more productively, e.g. handling a larger number of cases per unit time; evidence may be reviewed automatically; quality management efficiency may be improved; and any (or some of the) disconnect or disagreement between interaction data and feedback data may be automatically resolved or minimized.

1. A method for revising a score associated with a computer-based interaction, the method comprising, using a computer processor:
traversing a score revision decision tree to categorize the interaction, based on interaction data and interaction feedback data associated with the interaction; and
selecting, based on the categorization of the interaction, an indication of a probability that the score associated with the interaction should be revised;
wherein interaction data comprises data extracted from the interaction; interaction feedback data comprises data extracted from feedback about the interaction; and the score revision decision tree comprises a decision tree data structure comprising at least one decision node, each decision node corresponding to at least one data point of the interaction data or interaction feedback data.

2. The method according to claim 1, further comprising:
normalizing the interaction data and the interaction feedback data.

3. The method according to claim 1, further comprising:
revising the score associated with the transaction based on the indication of a probability that the score associated with the interaction should be revised,
wherein revising the score comprises updating at least one value indicative of the score.

4. The method according to claim 1, wherein the interaction feedback data comprises at least one of:
an indication of feedback categories; and
an indication of feedback sentiment.

5. The method according to claim 1, wherein the interaction data comprises at least one of:
an indication of interaction categories;
an indication of interaction sentiment; and
an indication of interaction frustration.

6. The method according to claim 1, further comprising:
comparing the interaction data with the interaction feedback data to find a correspondence between the interaction data and the interaction feedback data,
wherein categorizing the interaction is further based on the correspondence.

7. The method according to claim 1, further comprising:
displaying to a user the indication of the probability that the score associated with the interaction should be revised; and
revising the score based on a user input, wherein revising the score comprises updating at least one value indicative of the score stored in a memory.

8. A system for handling a revision for a score of an interaction, the system comprising:
a memory;
a score revision decision tree; and
at least one processor configured to:
traverse the score revision decision tree to categorize the interaction, based on interaction data and interaction feedback data associated with the interaction; and
select, based on the categorization of the interaction, an indication of a probability that the score associated with the interaction should be revised;
wherein interaction data comprises data extracted from the interaction; interaction feedback data comprises data extracted from feedback about the interaction; and the score revision decision tree comprises a decision tree data structure comprising at least one decision node, each decision node corresponding to at least one data point of the interaction data or interaction feedback data.

9. The system according to claim 8, wherein the processor is further configured to:
normalize the interaction data and the interaction feedback data.

10. The system according to claim 8, wherein the processor is further configured to:
revise the score associated with the transaction based on the indication of a probability that the score associated with the interaction should be revised,
wherein revising the score comprises updating at least one value indicative of the score stored in the memory.

11. The system according to claim 8, wherein the interaction feedback data comprises at least one of:
an indication of feedback categories; and
an indication of feedback sentiment.

12. The system according to claim 8, wherein the interaction data comprises at least one of:
an indication of interaction categories;
an indication of interaction sentiment; and
an indication of interaction frustration.

13. The system according to claim 8, wherein the processor is further configured to:
compare the interaction data with the interaction feedback data to find a correspondence between the interaction data and the interaction feedback data,
wherein categorizing the interaction is further based on the correspondence.

14. The system according to claim 8, wherein the processor is further configured to:
display to a user, using an output device, the indication of the probability that the score associated with the interaction should be revised; and
revise the score based on a user input, wherein revising the score comprises updating at least one value indicative of the score stored in the memory.

15. A method for determining whether to revise a score associated with an interaction, the method comprising:
sending interaction surveys to customers using customer personal information data;
receiving interaction survey responses from the customers;
searching each interaction survey response for indications of negatively reported customer interactions;
assigning a low score to interactions where there exist indications of negatively reported customer interactions; and
applying a recommendation engine to produce an indication of whether or not the low score is accurate;
revising the low score if the recommendation engine indicates the low score is not accurate;
wherein the recommendation engine comprises a decision tree data structure for categorizing the interaction based on data associated with the interaction.

16. The method according to claim 15, further comprising:
displaying the low score to an agent; and
only if the agent disputes the low score:
applying a recommendation engine to produce an indication of whether or not the low score is accurate, and
revising the low score if the recommendation engine indicates the low score is not accurate.

17. The method according to claim 15, wherein:
data associated with the interaction includes interaction data extracted from a recording of the interaction.

18. The method according to claim 15, further comprising:
importing customer personal information data from a database.

19. The method according to claim 15, wherein applying a recommendation engine to produce an indication of whether or not the low score is accurate comprises:
traversing the decision tree structure to categorize the interaction, based on the data associated with the interaction; and
selecting, based on the categorization of the interaction, an indication of whether or not the low score is accurate.

20. The method according to claim 15, further comprising:
displaying an indication that the low score is not accurate to a supervisor; and
revising the low score if the supervisor indicates that the low score should be revised.
